(19) United States
(12) Patent Application Publication
(10) Pub. No.: US 2015/0172418 A1
(43) Pub. Date: Jun. 18, 2015

(54) Real-Time Model-Based Collaboration and Presence

(71) Applicant: Assemble Systems LLC, Houston, TX (US)

(72) Inventors: Quentin Davis, Houston, TX (US); Everett Trent Miskelly, Houston, TX (US)

(73) Assignee: Assemble Systems LLC, Houston, TX (US)

(21) Appl. No.: 14/105,717

(22) Filed: Dec. 13, 2013

(51) Int. Cl. H04L 29/06

(52) U.S. Cl. CPC H04L 67/42; H04L 65/403

(57) ABSTRACT

Techniques (systems and methods and their embodiment in computer readable media) are disclosed for providing multiple parties a common view, and joint-control of that common view, into a high-fidelity model. Illustrative embodiments are described in the context of building information modeling systems, although the disclosed concepts are not so limited.

### BACKGROUND

This disclosure relates generally to the use of complex models. More particularly, but not by way of limitation, this disclosure relates to the enhancement of modeling tools commonly used in Building Information Modeling (“BIM”) systems.

BIM is a process involving the generation and management of digital representations of a facility's constituent elements. In practice, BIM processes are often implemented using software that represents a facility as a collection of inter-related objects in an object-oriented database. In such implementations each object can represent the physical, functional and intrinsic characteristics of its corresponding element (captured in terms of geometric and non-geometric or parametric data). Each object may also carry or identify the relations it has with other objects (e.g., window to wall, and wall to room). In addition, most BIM software provides rendering engines that can create visual representations of the underlying model. This permits users to examine and interact with their models using three-dimensional (3D) views, orthographic/two-dimensional (2D) plans, and sections and elevation views of a model.

Building information models may be used during all phases of a facility's life cycle: initial design; construction; and building management and/or maintenance operations. All these uses can ideally involve the collaboration of many parties. For example, one common practice in the construction of large facilities is that of clash review and resolution. Once a clash list is detected through, for example, the application of BIM software clash detection functionality, a number of parties meet to review and discuss the list of clashes. It will be understood that a “clash” is where parts of the building (e.g., structural frame and building services pipes or ducts) may wrongly intersect. The need to physically meet and, sometimes, walk the construction site with one or more other people to inspect the identified clashes is a time-consuming but necessary task. There are many other tasks that also require multiple people to meet and review the item under construction (a building, an aircraft, a manufacturing floor, etc.). Thus, it would be beneficial to provide techniques (systems, devices and methods) that permit multiple parties to jointly review that which is being modeled.

### SUMMARY

In one embodiment the disclosed concepts provide the ability for multiple entities to collaboratively navigate a complex model. A method in accordance with one embodiment includes: a server device providing an interface to first and second client devices (e.g., via web-based browser applications); the server device receiving login requests from the client devices for access to a model environment and providing access thereto; the server device receiving and granting a request from the first client device to form a collaborative-presence group with the second client device and, in so doing, sending view information corresponding to the first client device's view of the model environment to the second client device so that each have a common view of the model environment; and the server device receiving an indication from the first (second) client device that it has changed its view of the model environment and, in response, sending view information corresponding to the changed view to the second (first) client device. The effect of the server's action is to establish a real-time bi-directional link between the view of one client device and one or more other client devices. As used herein, the model environment may be one or more of a two-dimensional representation of an environment, a three-dimensional representation of the environment, and a tabular layout of the environment. In some embodiments, the server device may send location information about the first (second) client device to the second (first) client device, the information allowing one client device to identify the location of the other client device within the model environment. In still other embodiments, the server device may facilitate additional communication channels between individual client devices participating in a collaborative navigation operation. These additional communication channels could be, for example, text based, voice based, video based, or a combination of these (wherein each communication channel may be used by two or more client devices at a time). A computer executable program to implement one or more of the disclosed methods may be stored in any media that is readable and executable by a computer system. Systems may also be fashioned to provide the collaborative navigation capabilities described herein.

### BRIEF DESCRIPTION OF THE DRAWINGS

FIG. 1 shows, in block diagram form, a collaborative environment in accordance with one embodiment.

FIG. 2 shows, in flowchart form, a collaborative presence operation in accordance with one embodiment.

FIG. 3 shows an alignment operation in accordance with one embodiment.

FIG. 4 shows co-navigation operations in accordance with one embodiment.

FIG. 5 shows a user interface in accordance with one embodiment.

FIG. 6 shows, in block diagram form, a computer system in accordance with one embodiment.

### DETAILED DESCRIPTION

This disclosure pertains to systems, methods, and computer readable media to facilitate the collaborative use of high-fidelity models. In general, techniques are disclosed for providing multiple parties a common view, and joint-control of that common view, into a high-fidelity model. As used herein the term “high-fidelity” refers to models that are sufficiently accurate as to permit the review of their constituent parts in a “realistic” or “near realistic” fashion.

In the following description, for purposes of explanation, numerous specific details are set forth in order to provide a thorough understanding of the inventive concept. As part of this description, some of this disclosure's drawings represent structures and devices in block diagram form in order to avoid obscuring the invention. In the interest of clarity, not all features of an actual implementation are described. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals may vary from one implementation to another. It will also be appreciated that such development efforts might be complex and time-consuming, but would nevertheless be a routine undertaking for those of ordinary skill in the design of modeling software systems having the benefit of this disclosure.

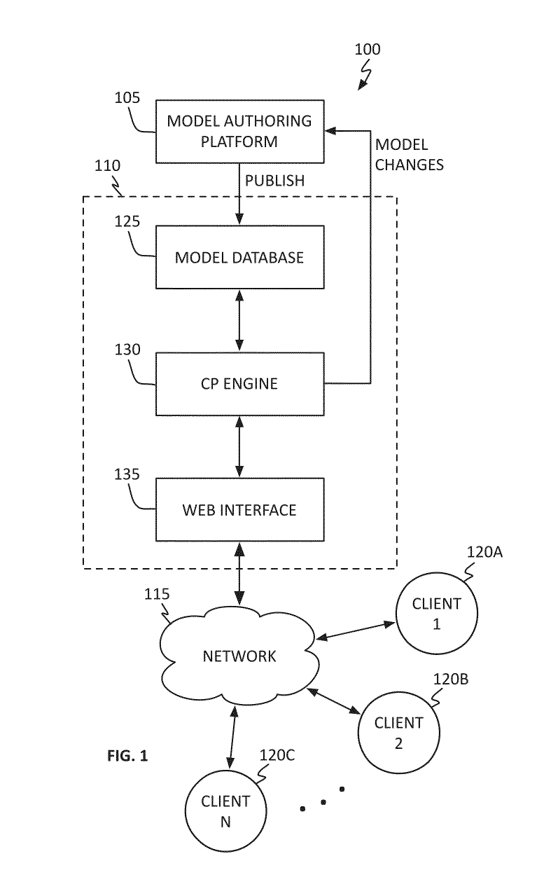

Referring to FIG. 1, in one embodiment collaborative environment 100 includes model authoring platform 105, collaborative presence system 110, network 115 and client or user devices 120A-120C. Model authoring platform 105 may be any suitable product from any number of vendors such as: Autodesk, Inc. (Revit® Architecture, Revit® Structure and Revit® MEP products); Bentley Systems (AECOsim Building Designer V8i, Architecture V8i, Building Electrical Systems V8i, Building Mechanical Systems V8i, Facility's V8i and Structural Modeler V8i products); Graphisoft (ArchiCAD®); Nemetschek AG (Vectorworks® and Allplan® products); Tekla, Inc. (Structures product); Gehry Technologies (Digital Project); and Design Master Software, Inc. (HVAC, Electrical, & Plumbing Engineering model design tools). Network 115 can include any suitable network (e.g., public or private, local or wide area, and wired or wireless) and may employ any suitable protocol (e.g., Ethernet, Internet Protocol, and Asynchronous Transfer Mode). In like fashion, client devices 120A-120C may be any suitable computer system (e.g., notebook, desktop, and workstation).

Referring again to FIG. 1, collaborative presence system 110 in accordance with one embodiment includes model database 125, collaborative presence (CP) engine 130 and web interface component 135. As shown, model authoring platform 105 may “publish” its model(s) into model database 125. One of ordinary skill in the art will recognize that, while a single model authoring platform is illustrated in FIG. 1, in practice there may be any number of different authoring platforms providing input to model database 125. For this reason, and to provide an easier path to the inclusion of future (currently unknown) authoring platforms, model database 125 may be a “normalized” representation of the various models. A user generally “publishes” one or more versions of a model. Each version differing from the prior version by user- or system-supplied model changes. Collaborative presence engine 130 is the component that provides and/or facilitates the necessary communication and synchronization between users to support collaborative presence operations (e.g., via client devices 120A-120C). As used herein, the term “collaborative presence” means the real-time two-way sharing of a user's context with one or more other users (e.g., via client devices 120A-120C). The term “context” means a user's view of, or into, a model or workspace and may be thought of as a “snapshot” of where the user is, and what the user sees, within the model. As used herein, the term “workspace” is used generally to mean that copy or version of a model a user is currently interacting with. In one embodiment, a workspace may be defined by one or more filters, where each filter acts as a predicate used to determine which properties of a model to display (e.g., show doors, show windows, show wire-frame representation, and whether the information should be presented in tabular or table format). In one embodiment, CP engine 130 may be implemented as one or more software modules that execute on a server computer system. The server computer system, in turn, may be composed of one or more separate computing elements, each of which may employ one or more processors (general and/or special purpose). Each of the computing elements may be co-located or distal from one another and may be coupled through one or more networks (e.g., network 115). Web interface component 135 provides a user interface between CP engine 130 and client devices 120A through 120C. It should be understood that while collaborative presence system 110 is being described as providing access through web interface, this is not required. For example, collaborative presence system 110 could be accessed by a stand-alone application executing on any appropriate computational platform (e.g., desktop, laptop or tablet computer system, or a mobile telephone or entertainment device such as an Apple iPod Touch®). Also shown in FIG. 1 is a path from CP engine 130 to model authoring platform 105. It will be recognized that, after some number or type of modifications have been supplied to their source authoring tool, the publish operation may be repeated so that model database 125 includes the revised version of the modeled article. In another embodiment, collaborative presence system 100 provides a “view only” perspective of the modeled article (i.e., users are not able to make changes to the model). In yet another embodiment, collaborative presence system 100 permits users to update, change or create non-geometric data associated with the model (e.g., annotations, comments, review history listings, etc.). In still another embodiment, asynchronous viewpoints, comments and markups may be used as navigational shortcuts during the course of a real-time session. For example, a saved viewpoint could be used to co-navigate one or more users to a pre-defined location within a model, including a markup, such as a redlined area, and comment to provide context for the pre-defined viewpoint. From that location within the model, the group of one or more users could navigate the model to provide additional context.

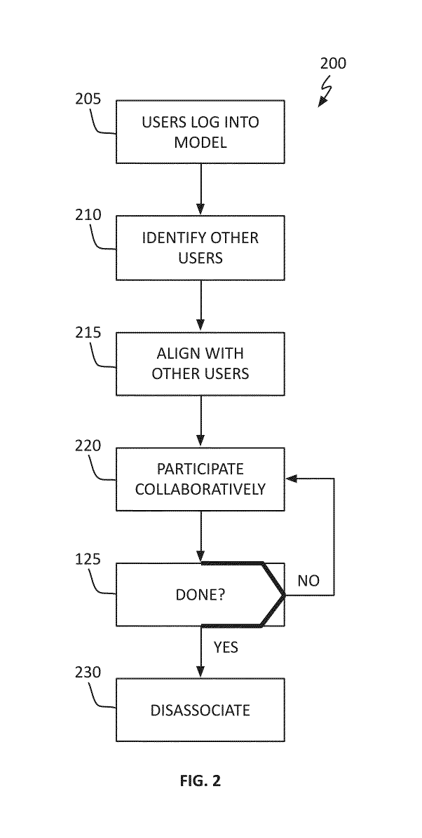

Referring to FIG. 2, collaborative presence operation 200 (e.g., using collaborative presence system 100) may begin after two or more users log into, or access, a common model (block 205). One user may then identify one or more other users with which they want to collaborate (block 210). The user may then “align” themselves with the other identified users (block 215), after which they may collaborate—exercise collaborative presence (block 220). Each user may continue to collaborate until they decide they are done (block 225), at which time they may disassociate from the other users (block 230) and return to a “solo” mode of using the model. Disassociation in accordance with block 230 may consist of removing a user from a collaborative presence group. In one embodiment, after disassociation a user's navigation no longer affects any other user, nor does any other user's navigation affect the disassociated user. In addition, the disassociated user is unable to participate in the group's collective communications (e.g., synchronous chat).

Aligning one user with another user in accordance with block 215 is the act of synchronizing the parties so that they share a common view and context of/into the model and may also include the establishment of one or more other communication links. In one embodiment, for example, a synchronous chat session between aligned users may be established. In another embodiment, an audio link between aligned users may be established. In yet another embodiment, a video session between aligned users may be established. In still another embodiment, combinations of these communication links may be employed. In one embodiment communication within a collaborative presence group may be group-wide (i.e., broadcast) or to only selected member(s) of the group (e.g., chat and some audio links). By way of example only, embodiments using a TCP/IP based communication's backbone and client devices executing web browser applications to interface with a collaborative presence engine, WebSockets may be used to provide full-duplex communications between members of a collaborative presence group. (The WebSockets protocol has been standardized by the Internet Engineering Task Force (IETF) as RFC 6455.)

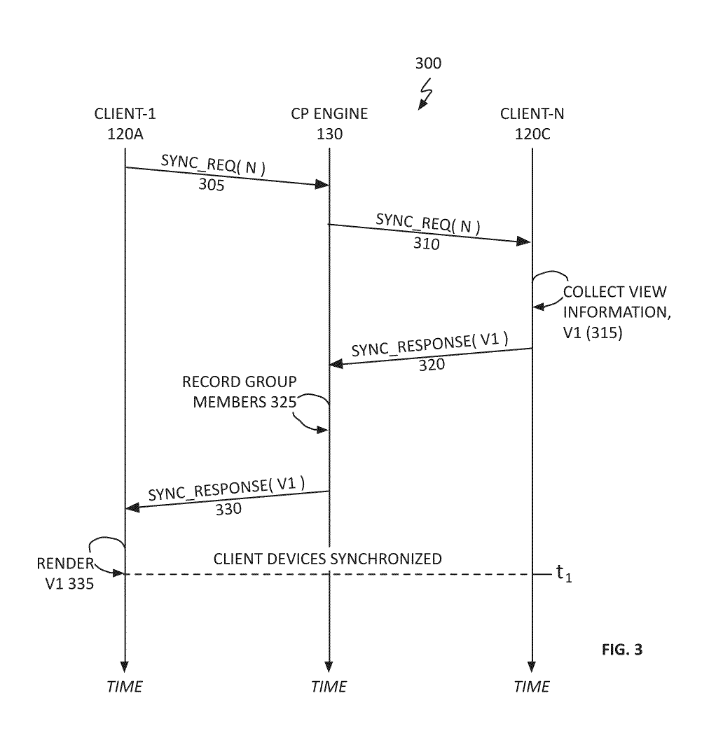

Referring to FIG. 3, illustrative alignment process 300 aligns user-1 (e.g., using client device 120A) with user-N (e.g., using client device 120C). Initially, user-1 sends a request to synchronize with user-N to CP engine 130 (305). Collaborative presence engine 130 may note the request and pass it to user-N (310). In response, user-N collects all of the information necessary for user-1 to replicate user-N's context (315) and forwards the collected view information to CP engine 130 (320) which may record the establishment of a collaborative presence group, its members, and location within the model (325) before, or simultaneously to, forwarding the view information to user-1's client device (330). On reception, user-1's client device may use the view information to render a view identical to that of user-N so that at time t₁, user-1 and user-N are synchronized. By way of example, if user-N is located at a specific junction of two hallways facing east in a 3D model of a building, so too will user-1.

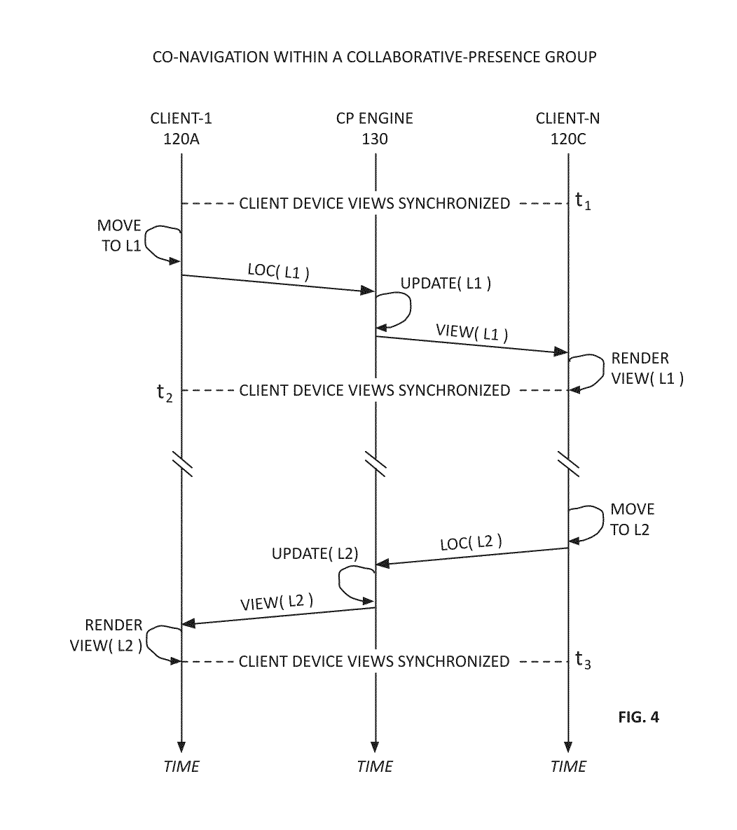

Referring to FIG. 4, after time t₁ any navigation (e.g., rotation, pan, zoom, or translation) undertaken by either user will be reflected in the other's view. By way of example, if user-1 (e.g., using user device-1 120A) navigates to new location L1, the necessary view information will be passed through CP engine 130 so that user-N (e.g., user device 120C) may also move so that they are again synchronized at time t₂. User-N may, in turn, move from location L1 to new location L2. Such action will cause user-N's new view information to be passed to user-1 (through CP engine 130) so that, at time t₃ they are again synchronized. Collaborative presence permits multiple users to see into a model through a “common set of eyes,” while maintaining their individual voices (e.g., through synchronous chat).

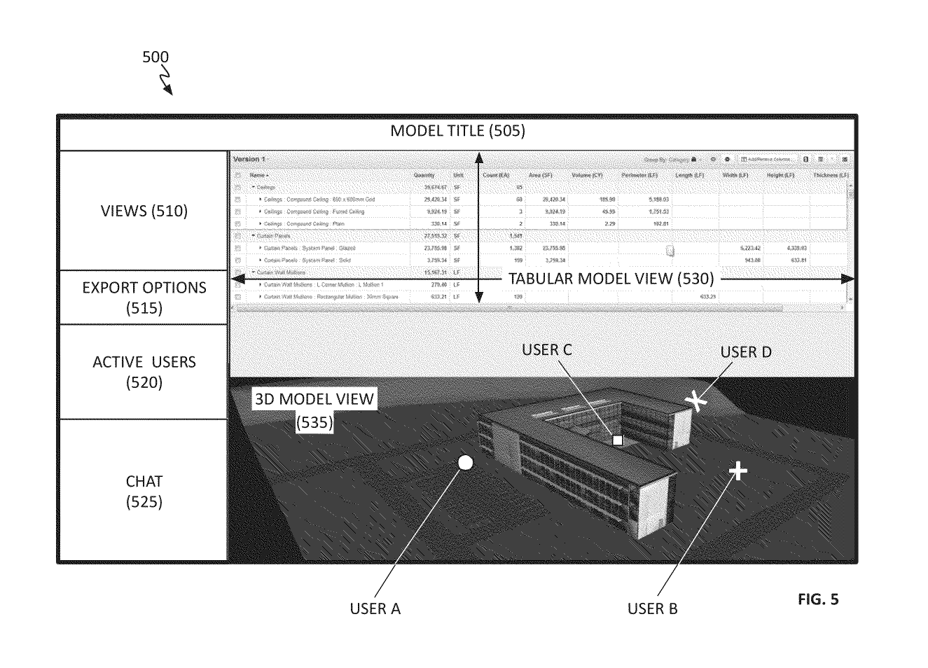

Referring to FIG. 5, in one embodiment a user's access to collaborative presence system 110 may be through web- or browser-based application 500 (e.g., as driven by web interface component 135). As shown, the illustrative interface includes title section 505, a list of previously defined views of the identified model 510, a list of some export options 515 (e.g., export selected model objects to a comma separated value file or a 3D PDF file), a listing of currently active users 520 (e.g., users A, B, C, and D), chat area 525, and two different views of the model: tabular or table view 530 (e.g., displayed in a spreadsheet style) and 3D view 535. Using illustrative interface 500, a user may initiate an alignment operation with a “target” other user (see discussion above and FIG. 3) by “clicking” on the target user's indicator in region 520. In another embodiment, a user may use a “drop-down menu” (not shown) to identify and target a user for contact.

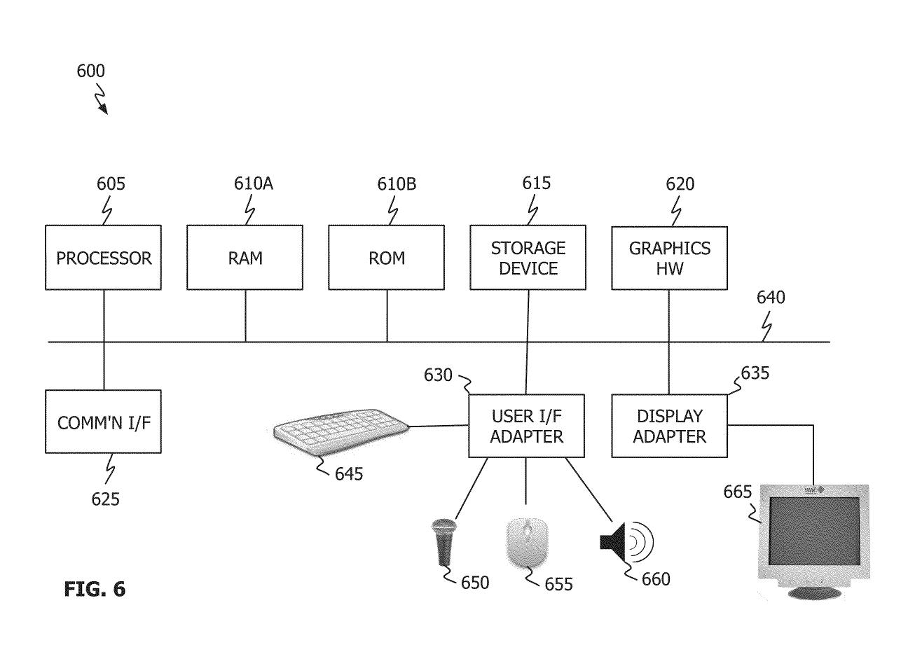

Referring to FIG. 6, representative computer system 600 (e.g., a general purpose computer system or a dedicated server/workstation) may be used to implement model authoring environment 105, collaborative presence system 110, and client devices 120A-120C, may include one or more processors 605, memory 610 (610A and 610B), one or more storage devices 615, graphics hardware 620, communication interface 625, user interface adapter 630 and display adapter 635—all of which may be coupled via system bus or backplane 640. Memory 610 may include one or more different types of media (typically solid-state) used by processor 605 and graphics hardware 620. For example, memory 610 may include memory cache, read-only memory (ROM), and/or random access memory (RAM). Storage 615 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 610 and storage 615 may be used to retain media (e.g., audio, image and video files), preference information, device profile information, computer program instructions organized into one or more modules and written in any desired computer programming language, and any other suitable data. When executed by processor 605 and/or graphics hardware 620 such computer program code may implement one or more of the methods and operations described herein. Communication interface 625 may be used to connect computer system 600 to one or more networks (e.g., network 115). User interface adapter 630 may be used to connect keyboard 645, microphone 650, pointer device 655, speaker 660 and other user interface devices such as a touch-pad and/or a touch screen (not shown). Display adapter 635 may be used to connect one or more display units 665.

Processor 605 may be a system-on-chip such as those found in mobile devices and include a dedicated graphics processing unit (GPU). Processor 605 may be based on reduced instruction-set computer (RISC) or complex instruction-set computer (CISC) architectures or any other suitable architecture d may include one or more processing cores. Graphics hardware 620 may be special purpose computational hardware for processing graphics and/or assisting processor 605 process graphics information. In one embodiment, graphics hardware 620 may include one or more programmable graphics processing unit (GPU) and other graphics-specific hardware (e.g., custom designed image processing hardware).

It is to be understood that the above description is intended to be illustrative, and not restrictive. The material has been presented to enable any person skilled in the art to make and use the claimed inventive concepts and is provided in the context of particular embodiments, variations of which will be readily apparent to those skilled in the art (e.g., some of the disclosed embodiments may be used in combination with each other). For example, while the presentation above has used BIM processes and their resulting building information models to present novel ideas or concepts, the use of such ideas and concepts is not so limited. For instance, the design of modern commercial aircraft and manufacturing processes are also complex and typically involve many parties. The use of models in these design operations may also benefit from the co-navigation or collaborative presence operations described herein. Another field that may benefit from the disclosed technology is the commercial real estate field where prospective purchasers could be taken on a virtual tour of a site (assuming there is a high-fidelity model of the site). This may be particularly useful for the sale or lease of newly built facilities.

It should also be noted that the system illustrated in FIG. 1 may be implemented using fewer or more components than those identified. For example, web interface element 135 could be combined into CP engine 130. Similarly, the flowchart illustrated in FIG. 2 may be implemented in any of a large number of ways using any number of different computer programming languages and hardware and may perform the identified functions in a different order than that shown (e.g., single-threaded and multi-threaded implementations may perform some of the identified functions in a sequence other h that shown). Accordingly, the specific arrangement of steps shown in FIG. 5 should not be construed as limiting the scope of the technique. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory program storage device comprising instructions stored thereon to cause a computer system to:
provide, from a server device, an interface to first and second client devices, wherein each of the first and second client devices are different from the server device;
receive, at the server device, login requests from the first and second client devices for access to a model environment;
allow, at the server device and in response to the login requests, access to the model environment to the first and second client devices;
receive, at the server device, a request from the first client device to form a collaborative-presence group with the second client device;
send, from the server device and in response to the first client device's request, view information corresponding to a first view of the model environment to the first client device so that each of the first and second client devices have a view of the model environment corresponding to the first view;
receive, at the server device, input from the first client device indicating that the first client device has changed its view of the model environment from the first view to a second view;
send, from the server device and in response to the input from the first client device, view information corresponding to the second view of the model environment to the second client device;
receive, at the server device, input from the second client device indicating that the second client device has changed its view of the model environment from the second view to a third view; and
send, from the server device and in response to the input from the second client device, view information corresponding to the third view of the model environment to the first client device.

2. The non-transitory program storage device of claim 1, wherein each of the first and second client devices comprise web-browser applications.

3. The non-transitory program storage device of claim 1, wherein the model environment comprises a three-dimensional (3D) model, wherein some aspects of the 3D model comprise geometrical data and some aspects of the 3D model comprise non-geometrical data.

4. The non-transitory program storage device of claim 1, wherein the instructions to cause the computer system to allow access to the model environment comprise instructions to cause the computer system to send first initial view information corresponding to a first initial view of the model environment to the first client device and second initial view information corresponding to a second initial view of the model environment to the second client device, wherein the first initial view information is different from the second initial view information.

5. The non-transitory program storage device of claim 4, further comprising instructions to cause the computer system to:
send, from the server device to the first client device, information to allow the first client device to identify a location corresponding to the second initial view; and
send, from the server device to the second client device, information to allow the second client device to identify a location corresponding to the first initial view.

6. The non-transitory program storage device of claim 4, wherein view information comprises all of the information needed by a client device to render a specified view of the model environment.

7. The non-transitory program storage device of claim 1, wherein the specified view comprises a three-dimensional representation of a model environment.

8. The non-transitory program storage device of claim 1, wherein the specified view comprises one or more of a two-dimensional representation of a model environment, a three-dimensional representation of the model environment, and a tabular representation of the model environment.

9. The non-transitory program storage device of claim 1, wherein the instructions to cause the computer system to receive a request to form a collaborative-presence group comprise instructions to cause the computer system to send view information corresponding to each change in view of the model environment received from the first client device to the second client device and versa-visa.

10. The non-transitory program storage device of claim 9, further comprising instructions to cause the computer system to provide two-way textual communication between the first and second client devices.

11. A non-transitory program storage device comprising instructions stored thereon to cause a computer system to:
receive, at a first client device, first view information corresponding to a first view of a model environment from a first location in the model environment, the first location associated with the first client device, wherein the first view information further includes an indicator indicative of a second location in the model environment that is associated with a second client device;
display, at the first client device, the first view information;
send, from the first client device, a request to form a collaborative-presence group with the second client device;
receive, at the first client device in response to the request to form a collaborative-presence group, second view information corresponding to a second view of the model environment from the second location;
display, at the first client device, the second view information;
send, from the first client device, movement information indicative of movement of the first client device from the second location in the model environment to a third location in the model environment;
receive, at the first client device, third view information corresponding to a movement of the second client device from the third location in the model environment to a fourth location in the model environment; and
display, at the first client device, the third view information.

12. The non-transitory program storage device of claim 11, wherein the instructions to cause the computer system to receive first view information comprise instructions to cause the computer system to:
send, from the first client device, a request to log into a model server computer system; and
receive, at the first client device and in response to the request to log into the server computer system, access to the model environment.

13. The non-transitory program storage device of claim 11 wherein the model environment comprises one or more of a three-dimensional representation of a model environment, a two-dimensional representation of the model environment, and a tabular layout of the model environment.

14. The non-transitory program storage device of claim 11 wherein the first client device provides a web-based graphical interface to the model environment.

15. The non-transitory program storage device of claim 11 wherein the indicator indicative of the second location in the model environment that is associated with the second client device comprises a visually distinctive indicator when displayed at the first client device.

16. The non-transitory program storage device of claim 11 wherein the indicator indicative of the second location in the model environment that is associated with the second client device comprises a visually distinctive color when displayed at the first client device.

17. A system, comprising:
a first client device;
a second client device;
a communications network; and
a server computer system communicatively coupled to the first and second clients by the communications network, comprising one or more processors, and
memory for storing instructions to cause the one or more processors to—
provide an interface to the first and second client devices,
receive login requests from the first and second client devices,
allow, in response to the login requests, access to a model environment by the first and second client devices,
receive a request from the first client device to form a collaborative-presence group with the second client device,
send, in response to the first client device's request, view information corresponding to a first view of the model environment to the first client device so that each of the first and second client devices have a view of the model environment corresponding to the first view,
receive input from the first client device indicating that the first client device has changed its view of the model environment from the first view to a second view,
send, in response to the input from the first client device, view information corresponding to the second view of the model environment to the second client device,
receive input from the second client device indicating that the second client device has changed its view of the model environment from the second view to a third view, and
send, in response to the input from the second client device, view information corresponding to the third view of the model environment to the first client device.

18. The system of claim 17, wherein the instructions to cause the one or more processors to receive a request from one of the first and second client devices to form a collaborative-presence group with another of the first and second client devices further comprise instructions to cause the one or more processors to:
send, in response to the first client device's request, a synchronization request to the second client device;
receive, from the second client device and in response to the synchronization request, location information corresponding to the second client device's location in the model environment; and
determine the view information corresponding to the other client device's location in the model environment.
